(19) United States
(12) Patent Application Publication
(10) Pub. No.: US 2011/0183276 A1
(43) Pub. Date: Jul. 28, 2011

(54) DEVICE AND METHOD FOR THE DEGASSING OF DUSTS

(75) Inventor: Stefan Hamel, Wenden (DE)

(73) Assignee: UHDE GMBH, Dortmund (DE)

(21) Appl. No.: 12/737,587

(22) PCT Filed: Jul. 29, 2009
(86) PCT No.: PCT/EP2009/005473

§ 371 Date: Apr. 8, 2011

(30) Foreign Application Priority Data
Jul. 31, 2008 (DE) 10 2008 035 604.2

(51) Int. Cl. F23C 7/00; B01D 49/00

(52) U.S. Cl. 431/3; 96/373; 95/39

(57) ABSTRACT

An apparatus for the degassing of a dust from a synthesis gas produced by a gasification process, is disclosed. The apparatus comprises a main dust separator, a multi-purpose vessel, fluid for degassing and cooling and a storage facility for dust. The synthesis gas produced is conducted via a connecting pipe to a main dust separator, from which a de-dusted raw synthesis gas stream and a dust-like solid which also contains raw synthesis gas in the voids between the dust particles can be removed. The dust-like solid is directed into a multi-purpose vessel equipped with devices for reducing the pressure level so that a tail gas is obtained and a solid containing lower gas quantities in the void fraction remains. There is a device for transporting a solid into a gas exchange apparatus, the latter comprising a gas exchange tank, a dust separator and a feed device for exchange gas. It is possible to reduce the gas exchange tank to atmospheric pressure. The gas exchange apparatus has an outlet for a solid that has been at least partially liberated from raw synthesis gas, said apparatus having an upwards-oriented conveyor in which an upwards-directed gas and solids stream can be established. The conveyor has an open cross-section, a bottom clear opening and a top clear opening. A feed device for exchange gas which is directed into the bottom clear opening is positioned underneath the bottom end of the conveyor. The dust separator has a discharge device for a tail gas stream and a downwards-directed connection into the gas exchange tank for a solid liberated from raw synthesis gas.

The invention relates to an apparatus for the degassing of dusts such as commonly occur during the production of synthesis gas in coal gasification reactions, synthesis gas being used here to refer to gas mixtures with widely varying degrees of purity that are used for different chemical syntheses and in addition to carbon monoxide and hydrogen usually also contain carbon dioxide, nitrogen, hydrogen sulphide and other components in varying combinations. The dusts are degassed so thoroughly that the toxic gases contained in the dust no longer pose an environmental hazard. The tail gas thus obtained can be collected by the apparatus and discharged from the system. By means of the apparatus in accordance with the invention it is possible to utilise the residual heat contained in the dusts and to cool the dusts obtained. During degassing the dusts are reduced in pressure by the apparatus from the high pressure level that normally prevails during coal gasification reactions to normal atmospheric pressure. The invention also relates to a process whereby the dusts from synthesis gases can be scrubbed and completely or almost completely degassed.

The thermal gasification of solid fuels, such as a wide variety of coals, turf, hydrogenation residues, other residues, refuse, biomasses and fly ash, or a mixture of these materials, is performed at elevated pressure and high temperature with the aim of generating a raw synthesis gas with a high energy content and/or with a composition favourable for subsequent chemical syntheses. The raw synthesis gas is laden with fly ash which originates from the ash content of the fuel feed. The fly ash is in the form of particles which need to be separated out before subsequent use. With dry separation, for example in a cyclone or a filter, the very fine-grained solid usually piles up before being discharged from the pressure chamber. There is, by nature, gas in the void fraction of the pile of particles, in this case raw synthesis gas that is discharged with the solid. Before final storage or removal, the solid has to be reduced in pressure and the raw synthesis gas still in the void fraction removed.

The relevant established state of the art with respect to the scrubbing of a synthesis gas from a coal gasification process is described in U.S. Pat. No. 4,838,898 A. US 2007/0084117 A1 illustrates a further production process for synthesis gas which directs the synthesis gas obtained from a coal gasification reactor consecutively through a system to mix it with a cooler foreign gas, a heat exchanger and a dust separator. The dust separator may be equipped with a feed device for a purge gas. There may be several subsequent dust separators downstream of the pressure let-down system to achieve a greater throughput. This permits the permeation of batches of fly ash with a purge gas at overlapping intervals in order to remove the undesirable gases during emptying and filling of the hoppers.

The stripping process is to be regarded as a time-determining step. Established processes provide for permeation of the fly ash pile to expel any remaining raw synthesis gas components. One of the main reasons why the established processes take a long time is that during permeation in the opposite direction to gravity, channels usually form through which the gas penetrates as the gas speed increases due to the very fine particle sizes of the fly ash. Due to this inhomogeneous permeation, the amount of time it takes to exchange the gas in the entire void fraction increases. During permeation in the opposite direction to gravity, there is a risk of the pile compacting due to the fine particles and the resultantly high flow resistance, which creates problems during emptying or transferring from the hopper.

Therefore, the objective is to provide an apparatus that returns fly ash from a synthesis gas from a coal gasification process stepwise to atmospheric pressure and removes the synthesis gas contained in the fly ash. The objective of the process carried out using the apparatus is also to exchange and return the gas which accumulates in the pressure let-down vessel and deduster during the emptying and filling processes.

The invention achieves the objective of degassing a dust from a synthesis gas produced by a gasification process in the form of an apparatus comprising
a main dust separator,
a multi-purpose vessel,
fluid for degassing and cooling,
a storage facility for dust,
   in which
the synthesis gas produced being conducted via a connecting pipe to a main dust separator, from which a dedusted raw synthesis gas stream and a dustlike solid which also still contains raw synthesis gas in the voids between the dust particles can be removed,
the dustlike solid being directed into a multi-purpose vessel equipped with devices for reducing the pressure level so that a tail gas is obtained and a solid containing lower gas quantities in the void fraction remains,
there being a device for transporting a solid into a gas exchange apparatus, the latter comprising
   a gas exchange tank,
   a dust separator,
   a feed device for exchange gas,
      in which
it being possible to reduce the gas exchange tank to atmospheric pressure,
the gas exchange apparatus having an outlet for a solid that has been at least partially liberated from raw synthesis gas,
the gas exchange apparatus having an upwards-oriented conveyor in which an upwards-directed gas and solids stream can be established,
the conveyor having an open cross-section, a bottom clear opening and a top clear opening,
the bottom clear opening of the conveyor being enclosed within the gas exchange tank near the bottom,
an exchange gas feed device directed into the bottom clear opening being positioned underneath the bottom end of the conveyor,
the dust separator being connected in such a manner that it can be supplied with a gas and solids stream from the gas exchange tank, and
the dust separator having a discharge device for a tail gas stream and a downwards-directed connection into the gas exchange tank for a solid liberated from raw synthesis gas.

One embodiment of the apparatus envisages there being a heat exchanger in the apparatus at any point in the process flow, said heat exchanger being designed as a cooler and positioned so that its cooling surfaces are in contact with the dustlike solid. Preferably, at least one such cooler is located in the gas exchange apparatus. Within said apparatus such a cooler may be located either in the process flow in the connection between the dust separator and the gas exchange tank or directly at the gas exchange tank; combinations are also possible.

Other embodiments of the apparatus envisage the dust storage facility having a pressure equalisation line that is connected to the dust separator of the gas exchange apparatus; the gas exchange tank and the dust separator may also form one structural unit.

The invention further achieves the objective of degassing a dust from a synthesis gas which is produced by a gasification process and usually contains CO and H₂, as well as ash and dust particles, by means of a process in which
the synthesis gas produced is directed via a connecting pipe into a main dust separator in which the majority of the dust is separated out,
once the dust has been separated out, the solids stream being directed at the same pressure level into a multi-purpose vessel in which said stream is reduced in pressure so that a tail gas stream is obtained and a solid containing lower amounts of gas in the void fraction remains,
the solids stream being directed from the multi-purpose vessel into a gas exchange apparatus pneumatically by means of transport gas, and
a solids circulation stream being produced within the gas exchange apparatus by means of an exchange gas, and
the tail gas liberated thereby being discharged via a dust separator.

For the cooling other embodiments of the process envisage the dust being cooled in the process flow in the connection between the dust separator and the gas exchange tank. It may also be envisaged that the dust is cooled in the gas exchange tank.

Another embodiment of the process envisages that the conveying density in the conveying line between the multi-purpose vessel and gas exchange tank is less than 75% of the bulk density of the dustlike solid.

Another embodiment of the process envisages the treatment of a batch in the gas exchange tank at the same time as part of the interstitial gas of the next batch is being removed in the multi-purpose vessel by adding exchange gas.

Other embodiments of the process alternatively envisage that the exchange gas forced into either the multi-purpose vessel, the gas exchange tank or both, is added either continuously or in batches, cyclically or in pulses during the gas exchange process.

Other embodiments of the process alternatively envisage that the exchange gas added is discharged in batches or continuously from either the multi-purpose vessel or the gas exchange tank together with at least part of the raw synthesis gas that is in the void space. The addition and discharge can in all cases be carried out separately and either continuously or in batches, which is an advantage of the invention due to the process flexibility thus achieved.

Other embodiments of the process concern the gas leaving the apparatus. Here, it may be envisaged that the exchange gas added to the gas exchange tank is fed to a disposal unit along with at least part of the raw synthesis gas in the void space once it has been separated from the circulating solid and has left the gas exchange apparatus. It may also be envisaged that the gas discharged from the multi-purpose vessel is fed to a disposal unit. It may further be envisaged that the exchange gas added is fed to a combustion reactor along with at least part of the raw synthesis gas in the void space once it has been separated from the circulating solid and has left the gas exchange apparatus, and that the gas discharged from the multi-purpose vessel is fed to a combustion reactor. It may further be envisaged that after being separated from the circulating solid and after leaving the gas exchange apparatus the exchange gas added together with at least part of the raw synthesis gas in the void space, or the gas discharged from the multi-purpose vessel, or both gases, first be fed to a gas holder for buffering and equalisation.

The apparatus described and the process described offer the advantage of a quick and thorough degasification of fly ash from a coal gasification process. The process described can significantly reduce the time required for the degasification of fly ash.

The apparatus in accordance with the invention is illustrated on the basis of three diagrams, these diagrams merely being examples of the design of the apparatus in accordance with the invention.

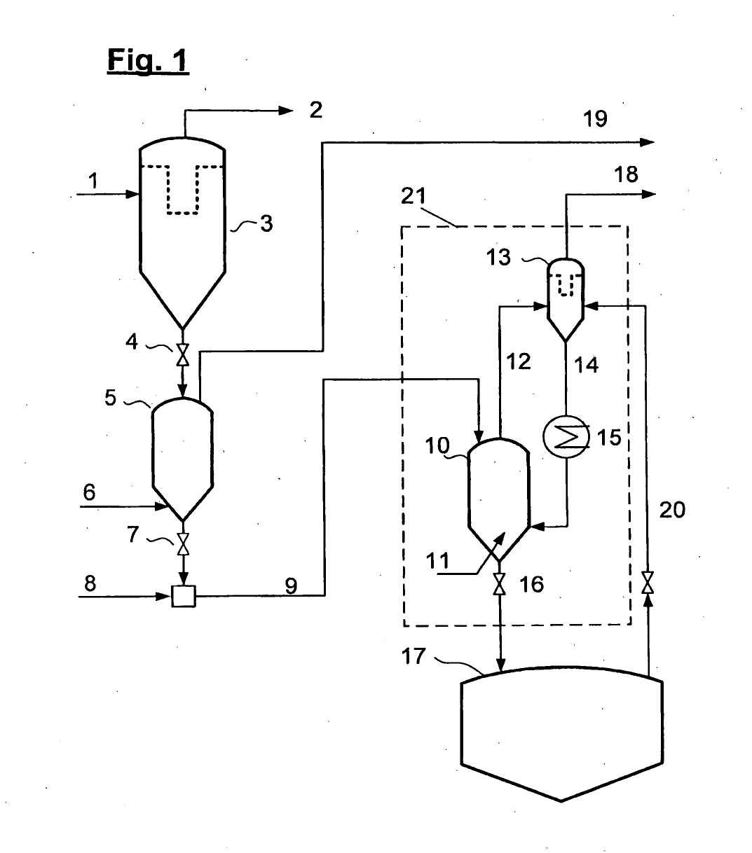

FIG. 1 shows the whole part of the apparatus designed for the degasification of the dust downstream of the outlet nozzle for synthesis gas.

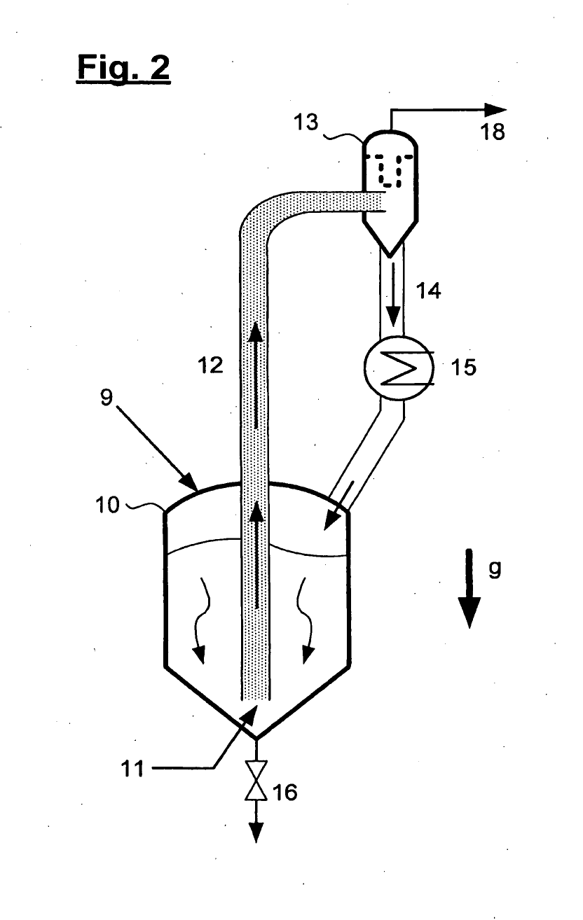

FIG. 2 shows the gas exchange apparatus 21 with the gas exchange tank 10 and the appurtenant dust separator 13.

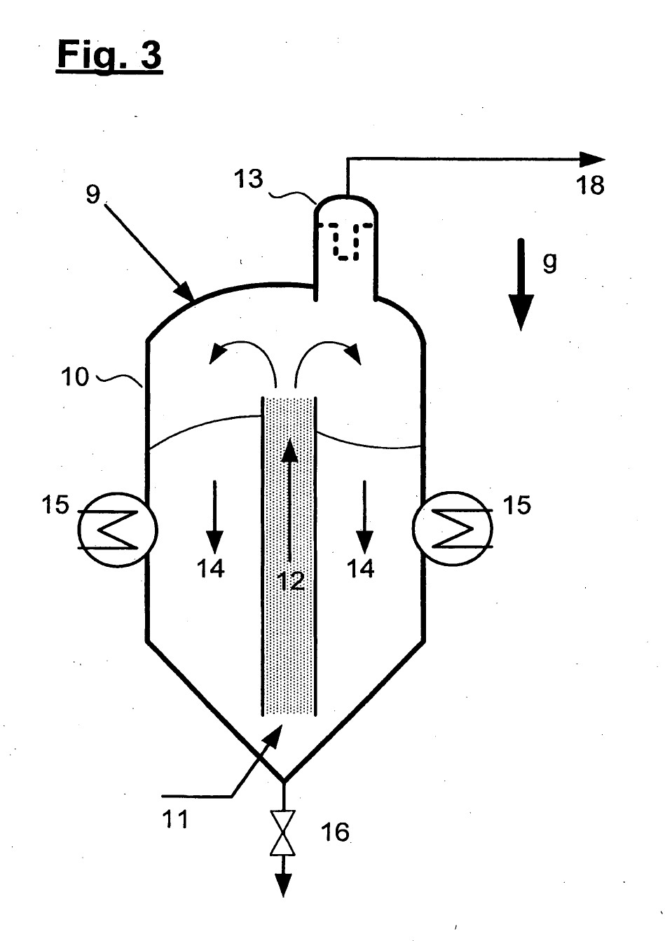

FIG. 3 shows the gas exchange tank 10 with an integrated dust separator 13.

Pressurised raw synthesis gas which contains fly ash 1 is directed into the fly ash separator 3, which may be designed as a filter or a cyclone. A dedusted synthesis gas 2 and fly ash 4 is thus obtained, the latter being directed into the multi-purpose vessel 5. In so doing, it is inevitable that small amounts of the raw synthesis gas in the void fraction of the pile of particles also get into the multi-purpose vessel 5. In the multi-purpose vessel 5 the fly ash that is still pressurised is reduced in pressure. Then the batch of solid 7 is conveyed into the gas exchange tank 10 of the gas exchange apparatus 21 via a pneumatic conveying line 9 by adding transport gas 8. In order to compensate for the volume of the solid conveyed from the multi-purpose vessel 5 and to maintain the pressure in the multi-purpose vessel 5, which acts as a blow vessel during discharge of the fly ash, exchange gas 6 is fed into the multi-purpose vessel 5.

When the batch has been forwarded to the gas exchange tank 10, exchange gas 11 is added such that an upwards-directed gas and solids stream 12 ensues. This gas and solids stream enters a separator, in which the solid is separated from the gas, so the solid 14 goes back down towards the place where it started off, where the upwards-directed gas and solids stream 12 is generated by adding gas 11. In this way circulation of the solid is achieved, which can be controlled via the geometric design of the gas exchange tank 10 and in particular via the gas feed 11. The gas which has been liberated from the solid leaves the gas exchange tank 10 either in continuous or batch mode.

In reality, simple classical permeation requires a considerable amount of time as only non-ideal permeation can be achieved due to the very fine dustlike particles, the reasons being, for example, channelling and plugging. Combining a scrubbing gas stream and circulation of the solid in accordance with the invention achieves optimum gas exchange between the pile which has been loosened by the movement of the solid and the scrubbing gas added. The intense upward stream of the solid ensures the best possible exposure of the gas in the void fraction to the exchange gas and mixing of the two. The desired or admissible residual concentration of raw synthesis gas components in the void fraction can easily be achieved via the number of circulations of the solid in relation to the amount of gas added 11.

Following separation from the raw synthesis gas, the temperature of the solid is in most cases too high to be stored or removed even after it has been transferred to the gas exchange tank. Therefore, heat transfer devices are provided which, in contact with the circulating solid, dissipate heat to achieve a target temperature of the solid. In the present example this is the heat exchanger 15.

Fly ash which has been degassed to the greatest possible extent is obtained from gas exchange apparatus 21 and fed to a silo 17 via a discharge system 16. The silo 17 is equipped with an equalisation line 20 which returns the gas displaced during filling to the dust separator 13. In addition, a tail gas 18 obtained from the dust separator 13 is disposed of in the same manner as the dedusted tail gas 19 obtained from the multi-purpose vessel 5.

FIG. 2 shows an external solids circulation loop. Here, the upwards-directed gas and solids stream 12 from the gas exchange tank 10 is directed to a dust separator 13 by adding exchange gas 11. Here, the solid is separated from the gas consisting of a mixture of the exchange gas added 11 and the gas from the void fraction of the pile of particles. The gas mixture 18 is fed to a disposal unit. The separated solid flows downwards in the direction of gravity towards the gas exchange tank 10. The heat exchanger 15, which is of the plate type, is designed as a heat transfer surface in the downward stream in order to dissipate the heat of the solid.

FIG. 3 shows the same principle, but with internal circulation, i.e. the solids stream circulates within the gas exchange tank 10. The gas exchange tank 10 of the apparatus according to the invention is equipped with an integrated dust separator 13 in this case. Again, heat transfer surfaces are provided for cooling the solid. For heat transfer two jacketed walls in the form of cooling jackets are provided as heat exchangers 15. In this case, the heat transfer surfaces should be immersed in the circulating solid during operation.

Other examples refer to the mode of operation. In a preferred process mode, the multi-purpose vessel 5 is used at the same time as a batch is being treated in the gas exchange tank 10 first to reduce the pressure of the next batch to be received, whereupon void fraction gas escapes, and then, during the remaining time, to raise the pressure again by means of the gas feed 6 and immediately afterwards to reduce the pressure again. Pressurisation causes a dilution of the raw synthesis gas content in the void fraction; the reduction in pressure expels part of the gas mixture then present. Depending on the time available this procedure can be repeated several times so that part of the raw synthesis gas is expelled from the void fraction even before the solids batch is conveyed to the gas exchange tank 10 for treatment. This reduces the number of circulations of the solid in the gas exchange tank 10, thus shortening the cycle times. Consequently, larger amounts of fly ash per unit of time can be liberated from the raw synthesis gas and cooled despite the single-line arrangement.

The vessel is herein referred to as a multi-purpose vessel 5 because it serves various purposes. Firstly, it serves as a lock hopper for receiving batches of solid at process pressure level and for reducing this pressure level. It also serves as a pre-scrubbing stage to remove in advance part of the raw synthesis gas from the pile by means of cyclic pressurisation and reduction in pressure, and secondly, it serves as a blow vessel for pneumatic conveyance to the main scrubbing stage in the gas exchange tank.

The exchange gases 6 and 11 and also the transport gas 8 may consist of inert gas, such as nitrogen, but air, carbon dioxide or the like may also be used. If the gas mixture stream 18 is fed to a post-combustion unit, for example, using air as the exchange gas 11 may be advantageous and also makes a contribution to reducing inert gas consumption.

An advantage of the downstream disposal unit for the tail gases 18 and 19, which is not shown here, is that the main scrubbing stage is operated quasi-continuously, only interrupted by the time intervals in which the next batch is delivered by the pneumatic conveyor. The result is that in terms of quantity an almost constant stream of tail gas 18 occurs, the treatment of which, from the process point of view, is easier than in the case of quantity peaks which occur during batch operation.

Another advantageous process variant of the pre-scrubbing stage consists in the batch not being cyclically pressurised with exchange gas and then reduced in pressure but pressurising it with a continuous stream at constant pressure. There would thus be no let-down gas stream peaks and the disposal unit for tail gas streams 18 and 19 would be pressurised with continuous streams from the pre-scrubbing stage and the main scrubbing stage.

### LIST OF REFERENCE NUMBERS AND DESIGNATIONS

1 Raw synthesis gas

2 Dedusted raw synthesis gas

3 Fly ash separator

4 Fly ash discharge

5 Multi-purpose vessel

6 Exchange gas

7 Discharge line for partially degassed fly ash

8 Transport gas

9 Pneumatic conveying line

10 Gas exchange tank

11 Exchange gas

12 Upwards-directed gas and solids stream

13 Dust separator

14 Solid

15 Heat exchanger

16 Discharge system

17 Silo

18 Tail gas

19 Tail gas

20 Equalisation line

21 Gas exchange apparatus

1-21. (canceled)

22. An apparatus for the degassing of a dust from a synthesis gas produced by a gasification process, comprising:
a main dust separator;
a multi-purpose vessel;
fluid for degassing and cooling;
a storage facility for dust;
a main dust separator;
a connecting pipe configured to conduct produced synthesis gas to the main dust separator (3);
the main dust separator being configured to produce a de-dusted raw synthesis gas stream and a dustlike solid which also contains raw synthesis gas in the voids between the dust particles;
a multi-purpose vessel configured to receive the dustlike solid, the multipurpose vessel being equipped with devices for reducing the pressure level so that a tail gas can be obtained and a solid containing lower gas quantities in the void fraction remains;
a device for transporting a solid into a gas exchange apparatus, the gas exchange apparatus comprising:
a gas exchange tank;
a dust separator; and
a feed device for exchange gas; wherein
it is possible to reduce the gas exchange tank to atmospheric pressure;
the gas exchange apparatus further comprises an outlet for a solid that has been at least partially liberated from raw synthesis gas;
the gas exchange apparatus further comprises an upwards-oriented conveyor in which an upwards-directed gas and solids stream can be established;
the conveyor having an open cross-section, a bottom clear opening and a top clear opening;
the bottom clear opening of the conveyor being located within the gas exchange tank near the bottom;
the apparatus further comprising an exchange gas feed device directed into the bottom free aperture positioned underneath the bottom end of the conveyor;
the dust separator being operatively connected in such a manner that it can be supplied with a gas and solids stream from the gas exchange tank; and
the dust separator has a discharge device for a tail gas stream and a downwards-directed connection into the gas exchange tank for the solid liberated from raw synthesis gas.

23. The apparatus for the degassing and cooling of a dust according to claim 22, wherein a heat exchanger is disposed in the apparatus at any point in the process flow, said heat exchanger being designed as a cooler and positioned so that its cooling surfaces are designed to be in contact with the dustlike solid.

24. The apparatus for the degassing and cooling of a dust according to claim 23, wherein at least one cooler is located in the gas exchange apparatus.

25. The apparatus for the degassing and cooling of a dust according to claim 24, wherein at least one cooler is located in the process flow in the connection between the dust separator and the gas exchange tank.

26. The apparatus for the degassing and cooling of a dust according to claim 24, wherein at least one cooler is located in or at the gas exchange tank.

27. The apparatus for the degassing of a dust according to claim 22, wherein the dust storage facility has a pressure equalization line that is connected to the dust separator of the gas exchange apparatus.

28. The apparatus for the degassing of a dust according to claim 22, wherein the gas exchange tank and the dust separator form one structural unit.

29. A process for degassing a dust from a raw synthesis gas which is produced by a gasification process and usually contains CO and H₂ as well as ash and dust particles, wherein:
the synthesis gas produced is directed via a connecting pipe into a main dust separator in which the majority of the dust is separated out; and
subsequent to the dust being separated out, the solids stream is directed at the same pressure level into a multi-purpose vessel in which said stream is reduced in pressure so that a tail gas stream is obtained and a solid containing lower amounts of gas in the void fraction remains, comprising:
directing the solids stream from the multi-purpose vessel into a gas exchange apparatus pneumatically by means of transport gas;
producing a solids circulation stream within the gas exchange apparatus by means of an exchange gas; and
discharging the tail gas liberated thereby via a dust separator.

30. The process for the degassing a dust according to claim 29, wherein in the process flow the dust is cooled in the connection between the dust separator and the gas exchange tank.

31. The process for the degassing a dust according to claim 29, wherein the dust is cooled in the gas exchange tank.

32. The process for the degassing of a dust according to claim 29, wherein the conveying density in the conveying line is less than 75% of the bulk density of the dust-like solid.

33. The process according to claim 29, wherein treatment of a batch in the gas exchange tank takes place at the same time as part of the interstitial gas of the next batch is being removed in the multi-purpose vessel by adding exchange gas.

34. The process for the degassing of a dust according to claim 29, wherein the exchange gas fed either to the multi-purpose vessel, the gas exchange tank or both is added continuously during the gas exchange process.

35. The process for the degassing of a dust according to claim 29, wherein the exchange gas fed either to the multi-purpose vessel, the gas exchange tank or both is added in batches, cyclically or in pulses.

36. The process according to claim 29, wherein the exchange gas added is discharged in batches from the gas exchange tank together with at least part of the raw synthesis gas that is in the void space.

37. The process according to claim 29, wherein the exchange gas added is discharged in batches from the multi-purpose vessel together with at least part of the raw synthesis gas that is in the void space.

38. The process according to claim 29, wherein during the gas exchange process the exchange gas added is discharged continuously from the gas exchange tank together with at least part of the raw synthesis gas that is in the void space.

39. The process according to claim 29, wherein during the gas exchange process the exchange gas added is discharged continuously from the multi-purpose vessel together with at least part of the raw synthesis gas that is in the void space.

40. The process according to claim 29, wherein after being separated from the circulating solid and after leaving the gas exchange apparatus, the exchange gas added to the gas exchange tank together with at least part of the raw synthesis gas in the void space, or the gas discharged from the multi-purpose vessel, or both gases are fed to a disposal unit.

41. The process according to claim 29, wherein after being separated from the circulating solid and after leaving the gas exchange apparatus the exchange gas added together with at least part of the raw synthesis gas in the void space, or the gas discharged from the multi-purpose vessel, or both gases, are fed to a combustion reactor.

42. The process according to claim 29, wherein after being separated from the circulating solid and after leaving the gas exchange apparatus the exchange gas added together with at least part of the raw synthesis gas in the void space, or the gas discharged from the multi-purpose vessel, or both gases, are first fed to a gas holder for buffering and equalization.
